(19) United States
(12) Patent Application Publication
(10) Pub. No.: US 2026/0062878 A1
(43) Pub. Date: Mar. 5, 2026

(54) Security Ground Post

(71) Applicants: Jeff Bonnett, Oklahoma City, OK (US); Sean Witley, Oklahoma City, OK (US); Phillip Burton, Elgin, IL (US); Roger Mucci, Elgin, IL (US)

(72) Inventors: Jeff Bonnett, Oklahoma City, OK (US); Sean Witley, Oklahoma City, OK (US); Phillip Burton, Elgin, IL (US); Roger Mucci, Elgin, IL (US)

(21) Appl. No.: 18/831,177

(22) Filed: Sep. 4, 2024

(51) Int. Cl. E01F 13/02; E05B 65/00

(52) U.S. Cl. CPC E01F 13/026; E05B 65/00

(57) ABSTRACT

A safety parking bollard to prevent theft of a vehicle or trailer comprising a ground base implanted within the ground using a plurality of stud anchors, a base plate engaging the ground base, a pole base within which is set a hollow pole, a pole lock bar fitting within the hollow pole rotatably locking a base end of the pole lock bar within the ground base, an inner theft pillar comprising a plurality of steel rods rotatably mounted within at least two pole caps to prevent a saw from cutting through the safety parking bollard in a horizontal plane, an upper locking plug blocking access to an upper opening of the hollow pole and a brass lock mounted within the upper locking plug to provide limited access to the safety parking bollard during installation and removal of the safety parking bollard by the unique locking means.

29

### CROSS REFERENCE TO RELATED APPLICATIONS

None

### I. BACKGROUND OF THE INVENTION

### 1. Field of Invention

A safety parking bollard to prevent theft of a vehicle or trailer comprising a ground base implanted within the ground using a plurality of stud anchors, a base plate engaging the ground base, a pole base within which is set a hollow pole, a pole lock bar fitting within the hollow pole rotatably locking a base end of the pole lock bar within the ground base, a inner theft pillar comprising a plurality of steel rods rotatably mounted within at least two pole caps to prevent a saw from cutting through the safety parking bollard in a horizontal plane, an upper locking plug blocking access to an upper opening of the hollow pole and a brass lock mounted within the upper locking plug to provide limited access to the safety parking bollard during installation and removal of the safety parking bollard by the unique locking means.

### 2. Description of Prior Art

A preliminary review of prior art patents was conducted by the applicant which reveal prior art patents in a similar field or having similar use. However, the prior art inventions do not disclose the same or similar elements as the present anti-theft vehicle safety bollard, nor do they present the material components in a manner contemplated or anticipated in the prior art.

A barrier for parking spaces is identified in U.S. Pat. No. 3,688,439 to Doxsee, which defines a pole hinged to a ground plate to be raised or lowered, an internal locking member and a lift mechanism which is reinforced by the post against bending or other distortion, and a lift handle which is mounted transversely to extend the span of the post to avoid vehicles traveling between adjacent posts. A key is required to raise and lower the post. A removable bollard assembly is shown in U.S. Pat. No. 11,920,310 to Mills having bollard residing in a tubular socket, an internal core separated from tube walls by an annular recess,, lifting elements inside the bollard to engage the upper surface of a core which are biased in favor of extension, with a locking system to prevent extension of the lifting elements to raise and lower the bollard above the socket without external assistance, allowing for removal of the sire of the socket.

A security barrier is disclosed in U.S. Patent Application Publication No. 2008/0025792 to Jessop including a ground mounted ground sleeve, an a jam member that is movable within the ground sleeve from a first free position to a second jammed position in engagement with the inner wall of the tubular sleeve. An elongated tension bar is installed within the tubular sleeve and is adapted to threadably engage an upper threaded portion of the tension bar which, by rotation, locks the tension bar into the jamming engagement with a tapered surface of the ground sleeve to prevent displacement. Similar device are shown in U.S. Patent Application Publication Nos. 2008/00380057 to Stadler, 2009/0250674 to Darey, 2011/0027015 to O'Connell, 2014/0154007 to Ustach, and 2020/0263375 to Hoe. Each having respective unique and distinguishable element as the present safety parking bollard.

### II. SUMMARY OF THE INVENTION

As seem by the numerous prior art patents, car theft is a problem that has several solutions which prevent movement of a vehicle or trailer while parked. Other methods include internal vehicle locking devices, vehicle disabling device, wheel locks, and movement blocking mechanisms. The present safety parking bollard is intended to prevent movement of a parked car, trailer or other vehicle. It provides locking engagement to the ground that cannot be removed until a locking means allows its removal. It provide a secure ground engagement that cannot be bypassed without intent. It also provides an internal mechanism to prevent the ability to saw horizontally through the bollard with a metal cutting saw, torch or other cutting device, and is not rotatable once established within the ground and fully engaged. It is difficult to remove the bollard once engaged, but in any event, would delay or inhibit a thief from quietly removing the bollard without alerting someone in the vicinity if the attempt to remove the bollard from the ground and away from the parked vehicle behind or in front of the safety parking bollard.

### III. DESCRIPTION OF THE DRAWINGS

The following drawings are submitted with this utility patent application.

FIGS. 1A and 1B are an exploded view of the components of the safety parking bollard.

FIG. 2 is an isolation upper perspective view of the inner anti-theft pillar.

FIG. 3 is an isolated view of the pole lock bar and with the dowel pins in an extended position.

FIG. 4 is an isolated view of the ground base, the base cover and stud ground anchors in relative alignment prior to installation into the ground.

FIG. 5 is an exploded view of the pole base, the hollow pole containing a plurality of dowel pin holes, the upper locking plug and the keyed brass lock which is one embodiment of a unique locking means and the ground base and base cover in relative vertical alignment.

FIG. 6 is a lower perspective view of FIG. 2.

FIG. 7 is a drawing of a pair of safety parking bollard in front of and behind an automobile, which indicates two placement embodiment options for installation of the safety parking bollards relative to the parked automobile.

### IV. DESCRIPTION OF THE PREFERRED EMBODIMENT

Stolen vehicles are a common occurrence and many different devices have been used to reduce the frequency of such criminal activities. Some devices disable a vehicle A so that it cannot be started, operated, or moved by an inner vehicle means. Some are installed within the vehicle to prevent steering, braking or engagement of a gear shift. Some employ electrical communication by a wireless key system that signals a vehicle ignition to start the vehicle A and its electrical system required for operation. Some are external means, including garages, fences, wheel locks and other means. The other means selected for the present safety parking bollard 10 is one manner using an external means to prevent directional movement of the vehicle A by prevention of forward and/or reverse movement to temporarily confine a vehicle A in a stationary position until the barrier or bollard is removed, allowing the vehicle A to move. Installing and securing this safety parking bollard 10, the vehicle A cannot be moved from its confined location it is deactivated and removed.

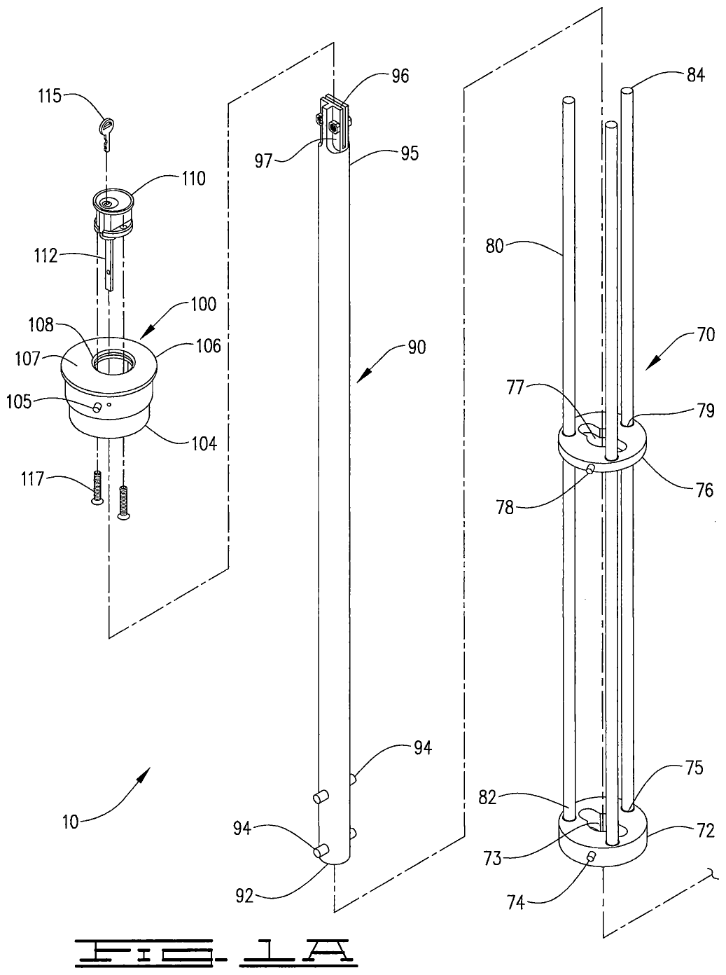

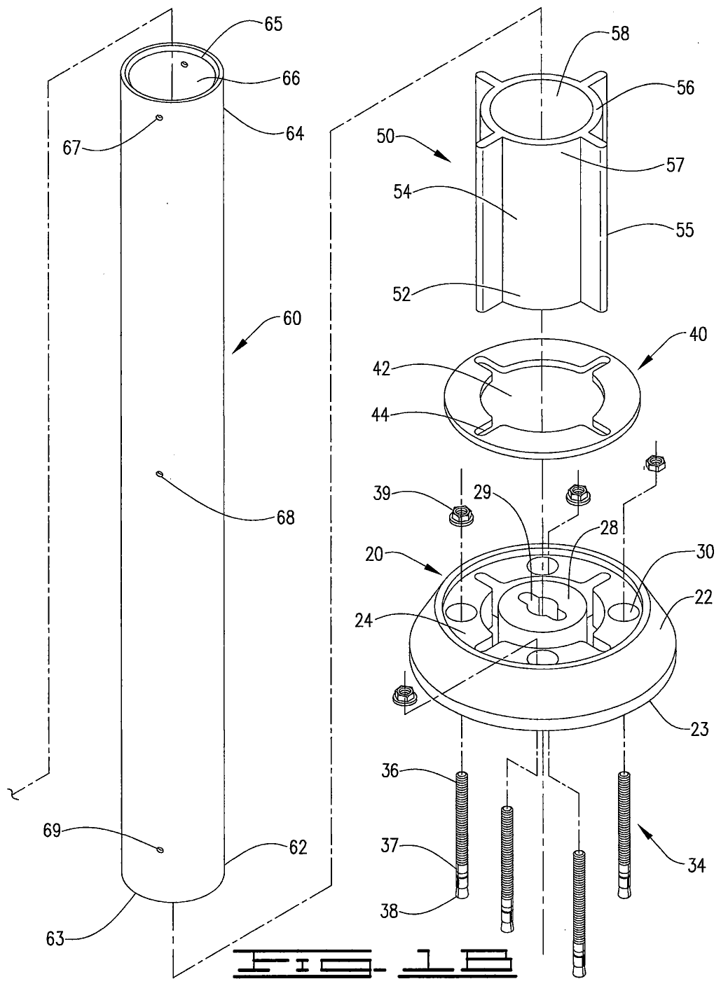

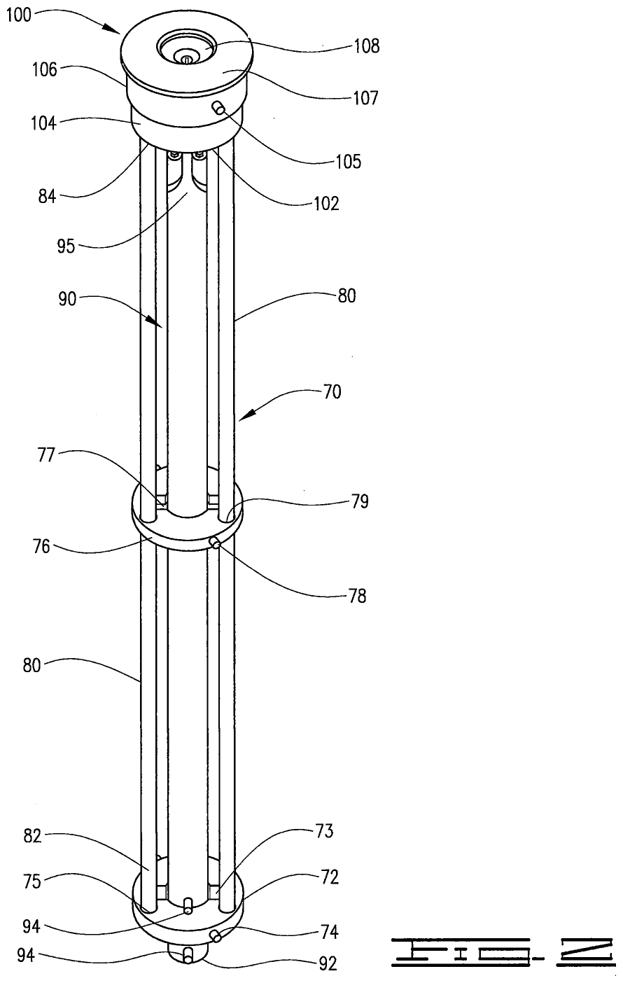

The present safety parking bollard 10, FIGS. 1A-7, comprises an assembly including a ground base member 20 installed upon an improved parking ground surface B by a plurality of ground anchor bolts 34 and a base ring cover 40 receiving a pole base 50 defining an upper pole slot 56, a hollow pole 60 installed within the pole base 50 and extending upward forming an inner linear channel 66, an anti-theft pillar 70 confining a plurality of rotatable rotating steel rods 80 which thwart a saw from cutting through the hollow pole 60 once installed within the inner channel 66, a pole lock bar 90 installed through the anti-theft pillar 70 inside the plurality of rotating steel rods 80 from above and surrounding the installed and engaged pole lock bar 90, a pole collar insert plug 100 secured within an upper opening 65 of the hollow pole 60, the pole collar insert plug 100 defining an upper lock receiver 108 within which is placed an upper lock 110. The ground base member 20 is the only component which is permanently attached to the ground surface B. The remaining elements engage the ground base member 20 either directly or indirectly to secure the other elements within the hollow pole 60 secured ultimately within the ground base member 20 making it immovable until it is intentionally uninstalled.

The ground base member 20, FIGS. 1B and 4-5, further comprises a flat lower surface 23 and a tapered upper surface 22 defining a recessed cavity 24 providing a plurality of bolt anchor channels 30 extending through the ground base member 20 to the flat lower surface 23, the bolt anchor channels 30 defining an upper expanded rim 32, the recessed cavity 24 also defining a plurality of fin extension slots 26 and a central lock pin pedestal 28 defining a lateral locking slot 29. An equal number of ground anchor bolts 34 are provided with an upper lock nut 39 engaging an upper threaded portion 36, the nut 39 securing the upper threaded portion 36 within each respective bolt anchor channel 30, with a lower portion 37 defining an expandable molly flare 38 which expands after insertion into the ground, the expandable molly flare 38 preventing removal of each ground anchor bolts 34 from a ground surface bore, which completes the secure installation of each ground anchor bolt 34 within the ground surface B as well as securing the installed ground base member 20 within the ground surface B.

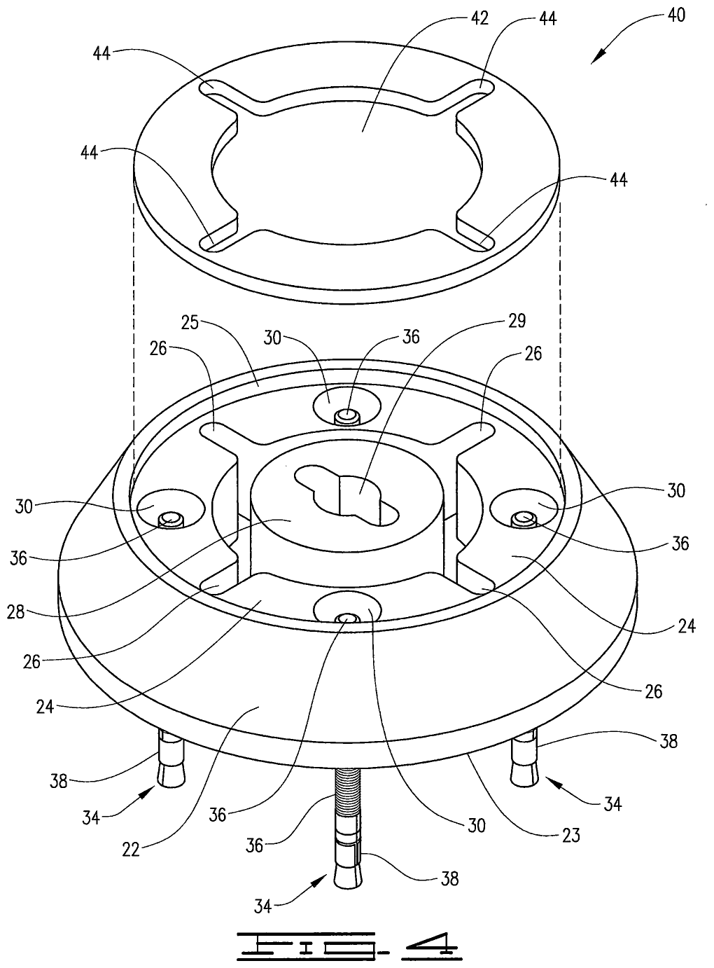

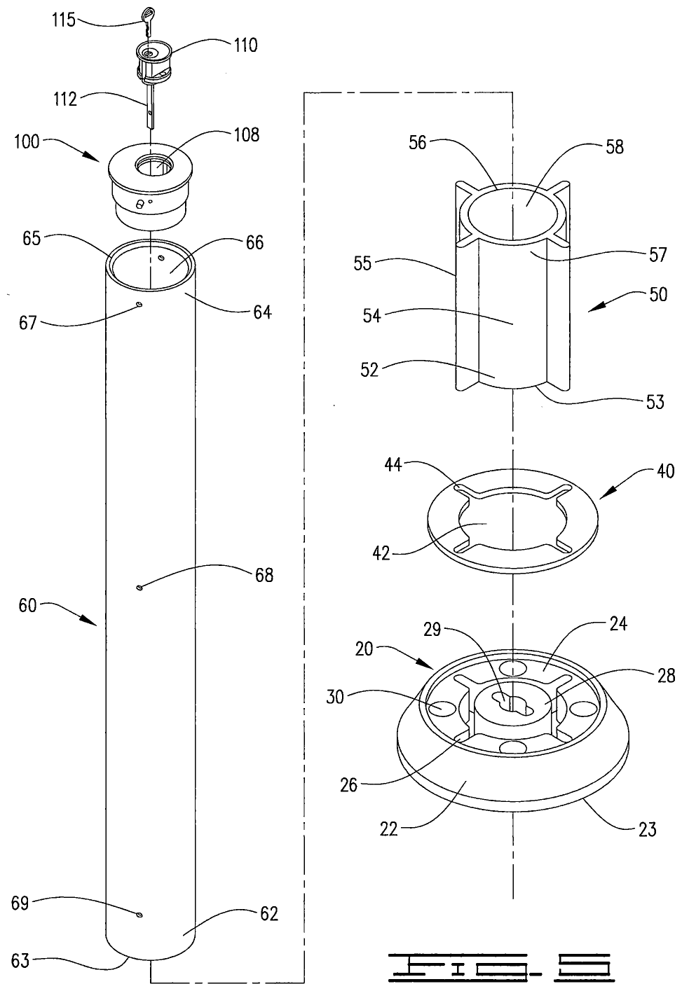

The base ring cover 40, FIGS. 1B and 4-5, is a flat ring defining a central bore 42 and matching plurality of fin extension slots 44 as in the ground base member 20 and is placed over the upper expanded rim 32 within the contour and an inner margin 25 of the recessed cavity 24, as shown specifically in FIGS. 4-5. A lower end 52 of the pole base 50 is installed within the base ring cover 40 and the ground base member 20 by inserting a plurality of radial fins 55 extending from an outer surface 54 of the pole base 50, being equal in number to the radial fin extension slots 26, 44, in the base ring cover 40 and ground base member 20, wherein the pole base 50 is restricted from rotation once installed. The pole base 50 further defines an upper pole slot 56, a lower pole slot 53 and an upper end 57 forming a hollow pole base tube 58.

The hollow pole 60, FIGS. 1B and 5, defines a lower end 62 forming a lower shaped opening 63, preferably cylindrical, an upper end 64 forming an upper shaped opening 65 and defining the inner linear channel 66, the lower end 62 being inserted within the upper end 57 of the pole slot 56 conforming to the shape and size of the hollow pole 60 forming a secure fit. The hollow pole 60 further defines two or more sets of laterally aligned pin holes 67-69, as shown in FIGS. 1 and 5, defining upper radial pin holes 67, medial radial pin holes 68 and lower radial pin holes 69 in the illustrated embodiment.

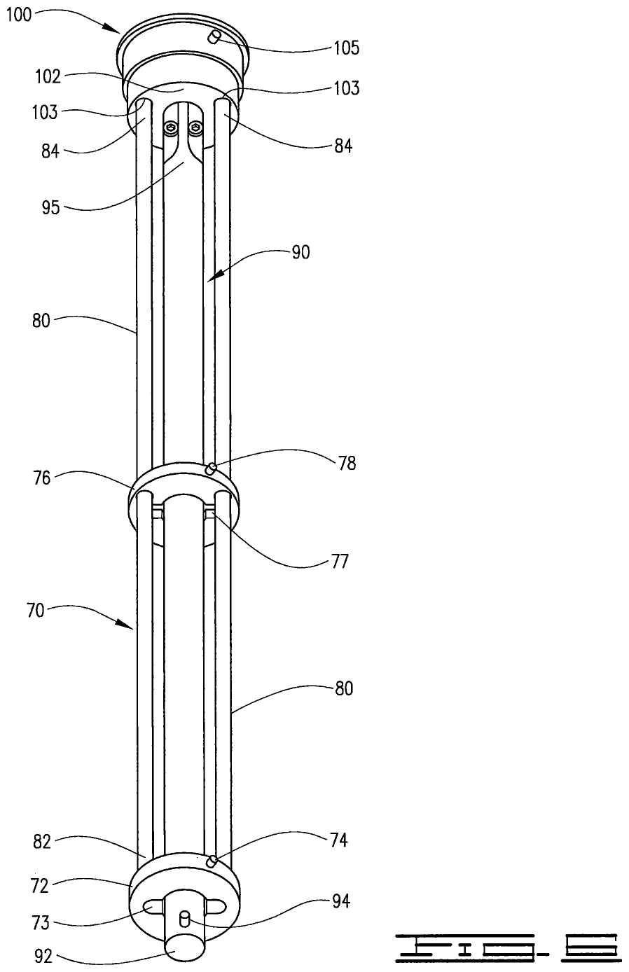

The anti-theft pillar 70, FIGS. 1A, 2 and 6, further defines a lower rod support receiver 72 with a central locking slot 73, identical in size and shape to that defined within the central lock pin pedestal 28, and extending a pair of lower retractable lock pins 74, an upper rod support receiver 76 with a central locking slot 77, also identical in size and shape to that defined within the central lock pin pedestal 28 and the lower rod support receiver 72, and also extending a pair of medial retractable lock pins 78. Also within the lower rod support receiver are at least three lower rod support bores 75, each capturing and allowing rotational engagement with a respective lower end 82 of each rotating steel rod 80, each rotating rod 80 further extending upward and through respectively vertically aligned rod channels 79 defined within the upper rod support receiver 76, each rod freely and independently rotating within each rod channel 79, each steel rod 80 further extending above the upper rod receiver to a terminal upper end 84. Each terminal upper end 84 of each steel rod 80 is further rotatably installed within formed respective receiver bores 103 in a lower surface 102 of the pole collar insert plug 100, FIG. 6, and as further defined below.

The pole lock bar 90, FIGS. 1A, 3 and 6, is a shaped linear metal rod having a lower end 92 defining a pair of radial fixed lower lock extension pins 94 aligned vertically and axially along the pole lock bar 90 and an upper end 95 defining a vertical lock channel slot 96 and shaped engagement key extension 97 providing biased rotation of the pole lock bar 90 by a tool, not shown, during installation and locking of the safety parking bollard 10 within the ground base member 20, including all the other components noted thus far.

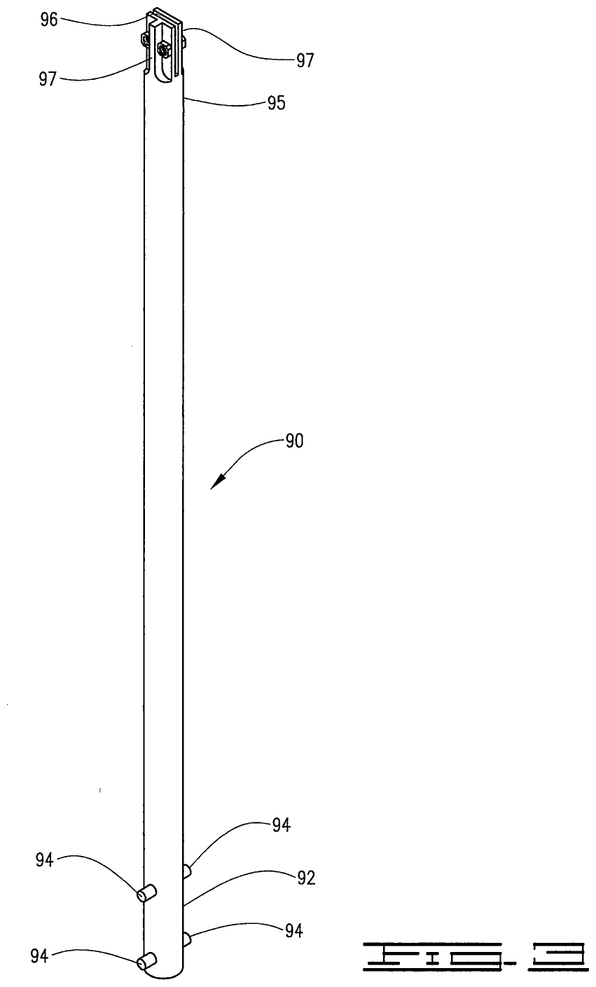

The pole collar insert plug 100, FIGS. 1A, 2, 5 and 6, provides a lower end 104 having a reduced profile to fit securely within the upper shaped opening 65 of the hollow pole 60 and extends a pair of lateral retractable locking pins 105, the previously defined lower surface 102 defining the formed respective rod receiver bores 103 in the lower surface 102 of the pole collar insert plug 100, the upper terminal ends 84 of the cylindrical rotating steel rods 80 and an upper end 106 defining a lock receiver 108 and an expanded collar 107 larger than the inner linear channel 66 at the upper opening 65 the hollow pole 60, completely blocking off all access to the inner linear channel 66 of the hollow pole 60 once installed and secured. The lock receiver 108 secures a metal lock 110 which may be secured within the lock receiver 108 by an optional lock attaching means 117, FIGS. 1A and 6, and a depending lock tang 112 which engages the vertical lock channel slot 96 to prevent rotation of the installed metal lock 110, FIGS. 3 and 5, the metal lock 110 requiring a key 115 to insert and remove the pole collar insert plug 100 after and prior to installation.

The lateral retractable locking pins 105 of the pole collar insert plug 100 are intended to mate with and engage the upper radial pin holes 67 of the hollow pole 60 contemporaneously with the engagement of the medial retractable lock pins 78 extending from the upper rod support receiver 76 engaging the medial radial pin holes 68 in the hollow pole 60 and the lower radial pin holes 69 engaging the lower retractable lock pins 74 extending from the lower rod support receiver 72 to prevent rotation of the anti-theft pillar 70 once inserted within the inner linear channel of the hollow pole 60, as indicated in the exploded diagram of FIGS. 1A and 1B. Optionally, these lateral retractable lock pins 105 cannot be depressed or removed from engagement with the upper radial pin holes 67 once the metal lock 110 is set within the lock receiver 108 and the lock tang 112 is installed within the vertical lock channel slot 96, wherein the metal lock must be disengaged to remove the pole lock collar insert plug 100 from the upper opening 65 of the inner linear channel 66 as allowed by compression of the lateral retractable lock pins 105. The lock attaching means 117 would not be employed in this embodiment where the insertion of the metal lock 110 bars movement of the lateral retractable lock pins 105.

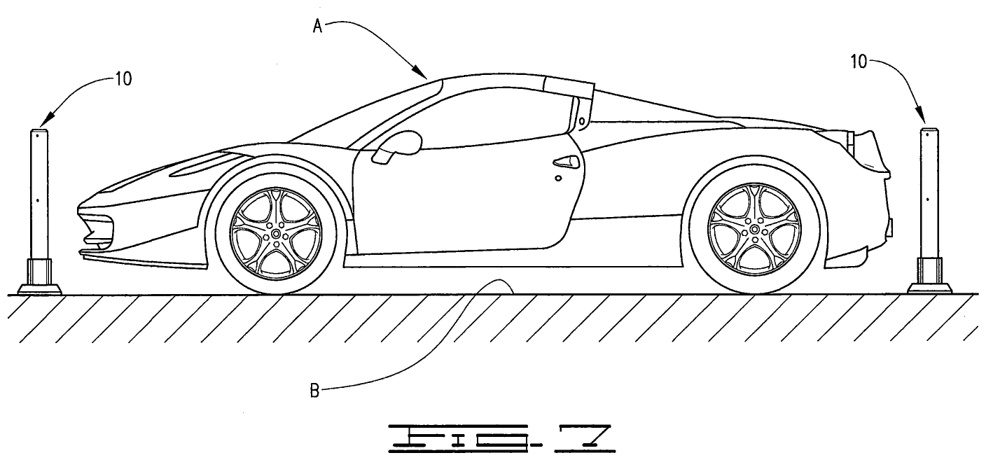

The process for installing and securing the safety parking bollard 20 would include selecting a ground surface B location either in front of or behind a vehicle A which is intended to be secured by the safety parking bollard 10, FIG. 7, to prevent movement in one direction or the other. Next, the ground base member 20 is installed in an intended ground surface B, including an outside concrete surface, parking garage or concrete floor in a storage facility. This is accomplished by drilling holes in the intended surface mating with the location of each ground anchor bolt 34 to be inserted through and secured ground base member 20. The base ring cover 40 is installed within the ground base member 20 and the fin extensions are matched between the ground base member 20 and the base ring cover 40 and the pole base 50 is inserted within the aligned fin extensions.

Next, the lower end 62 of the hollow pole 60 is inserted within the pole base 50. The anti-theft pillar 70 is then installed with inner channel of the hollow pole from the upper opening 65, with the lower lock pins 74 and the medial lock pins 78 being aligned and locked with the respective lower radial pin holes 69 and medial radial pin holes 68 of the hollow pole 60, thereby locking the anti-theft pillar 70 within the inner linear channel 66 of the hollow pole 60. It is not necessary that the central locking slots 73, 77 of the lower rod support receiver 72 and the upper rod support receiver 76 are positioned or aligned identically with the lateral locking slot 29 within the central lock pin pedestal 28, but it is also not prohibited. After the anti-theft pillar 70 is installed, the lower end 92 of the pole lock bar 90 is then inserted through the central locking slots 73, 77, of the upper rod support receiver 76 and the lower rod support receiver 72 sequentially, all the way through the lateral locking slot 29 in the central lock pin pedestal 28, with the pair of radial fixed lower lock extension pins 94 passing through each central locking slot 73, 77, after which the pole lock bar 90 is rotated by the shaped engagement tool extension 97 turning the vertical lock channel slot 96 on the upper end 95 of the pole lock bar 90 to secure the pole lock bar 90 within the ground base member 20 through the anti-theft pillar 70 by the now misaligned fixed lower lock extension pins 94 relative to the lateral locking slot 29 in the central locking pedestal 28, preventing vertical disengagement and removal of the pole locking bar 90 due to the fixed lower lock extensions 94 preventing disengagement of the pole lock bar 90 from the ground base member 20, similar to the inability of everyone except King Arthur from removing the sword Excaliber from the stone within which it was secured by Merlin.

The pole collar insert plug 100 is next installed within the upper opening 65 of the hollow pole 60 with the retractable locking pins 105 of the pole collar insert plug 100 mating with and engaging the upper radial pin holes 67 of the hollow pole 60. Finally, the metal lock 110 is secured within the lock receiver 108, the metal lock 110 requiring a proprietary key 115, FIGS. 1A and 5, to install and remove the metal lock 110 from the pole collar insert plug 100 after and prior to installation. At this point, the safety parking bollard 10 is secured at the installation site either in front of the car, trailer or other moveable equipment to prevent movement as indicated in FIG. 7. The person having authorization or possession of the proprietary key would thereafter be the only person who could disengage and remove the safety parking bollard 10, which would be the owner, authorized user, valet or premises owner or operator, provided the key is truly unique and/or proprietary.

The utility purpose of the anti-theft pillar 90 is now explained. Without the anti-theft pillar 90, it would be possible for a thief to saw horizontally through the hollow pole 60 and the pole lock bar 70 with a metal saw, thereby removing the safety parking bollard 10 without a key. With the anti-theft pillar 70 surrounding the pole locking bar 90 within the hollow pole 60, a saw blade can penetrate as small portion of the hollow pole 60, but once the saw blade its one or more of the rotatable steel rods 80, which are defined and required as at least three or more steel rods 80, rotatably engaged within the lower rod support receiver 72, the upper rod support receiver and the rod receiver bores 103 of the pole collar insert plug 100, the saw through effort is frustrated by the saw blade being unable to further penetrate the hollow pole because of the at least three having one or more steel rods 80 simply rotating with the sawing motion, thereby thwarting the thief's attempt to cut the hollow pole 60 all the way through to remove it from obstructing the thief's effort to move the vehicle A behind the safety parking bollard 10. The only way possible to remove the safety parking bollard 10 is to remove the safety parking bollard 10 is to unlock the metal lock to gain access to disengage the pole locking bar 90 from the assembly, at least within a short amount of time. Opening the metal lock 110 and rotating the pole lock bar 90 allows disengagement of everything above the ground base member 20, depending on the weight of the entire assembly, in the assembled embodiment and simply set aside the entire assembly above the ground base member 20, leaving the install ground base member 20 set within the ground surface B until such time as the assembly needs to be reinstalled, or the safety parking bollard 10 can be completely disassembled and either set aside or placed in the trunk of the vehicle for later installation upon return to the location of the ground base member 20.

While the safety parking bollard 10 has been particularly shown and described with reference to a preferred embodiment thereof, it will be understood by those skilled in the art that changes in form and detail may be made therein without departing from the spirit and scope of the invention.

What is claimed is:

1. A safety parking bollard blocking movement of a vehicle for anti-theft purposes comprising:
a ground base member secured to a ground surface by a plurality of ground anchor bolts;
a pole base secured to said ground base member and forming a hollow pole base tube and extending a plurality of radial fins fitted within fin extension slots of said ground base member preventing rotation of said pole base within said ground base member;
a hollow pole defining a lower end inserted within said hollow pole base tube and an upper end, said upper end and said lower end extending an inner linear channel within said hollow pole;
an anti-theft pillar securely installed within said hollow pole providing three or more rotating steel rods surrounding aligned upper and lower rods support receivers;
a pole locking bar defining a lower end extending two or more fixed lower locking extension pins inserted into the upper end of said hollow pole through said respective central locking slots of said upper and lower rod receivers into a lateral locking slot of said ground base member and rotated to lock and unlock said pole locking bar into said lateral locking slot within said ground base member retaining said pole base, said hollow pole and said anti-theft pillar in locking engagement with said ground base member; and
a pole collar insert plug installing and secured by a metal lock and proprietary key within said upper end of said hollow pole to prevent access to said inner linear channel after said pole locking bar is locked within said ground base member to prevent removal or rotation of a lower end of said pole locking bar as well as access to said inner linear channel by an expanded collar formed at said upper end.

2. The safety parking bollard of claim 1, said ground base member further comprising a tapered upper surface, a flat lower surface engaging a flat ground surface and anchored to said flat ground surface by said plurality of ground anchor bolts withing a recessed cavity defined within said ground base member, said ground recessed cavity further defining an inner margin with an upper expanded rim, a plurality of bolt anchor channels, and a central locking pedestal defining said lateral locking slot.

3. The safety parking bollard of claim 1, further comprising said cover base ring cover defining a central bore extending a plurality of fin extension slot seated within an inner margin of a recessed cavity within said ground base member, said fine extension slots of said cover base ring aligned with said fin extension slots of said ground base member.

4. The safety parking bollard of claim 1, said pole base further defining an outer surface extending a plurality of radial fins, an upper pole slot and a lower pole slot defining a hollow pole base tube within which said lower end of said hollow pole is inserted, said radial fins installed within said fin extension slots of said ground base member, said pole base fin extension slots preventing rotation of said hollow pole once installed within said ground base member.

5. The safety parking bollard of claim 1, said anti-theft pillar further comprising:
said lower rod support receiver defining a central locking slot, lower retractable locking pins and three or more lower rod support bores;
said upper rod support receiver defining a central locking slot, medial retractable locking pins and three or more vertical rod channels; and
three or more steel rods defining a lower end rotatably set within said lower rod support bores and passing through said vertical rod channels of said upper rod support receiver, each steel rod extending a terminal upper end above said upper rod support receiver into rod receiver bores located within a lower surface of said pole collar insert plug.

6. The safety parking bollard of claim 1, the pole locking bar further comprising an upper end further comprising a vertical channel slot adapted to receive depending lock tang from said metal lock to prevent rotation of said lock within said pole collar insert plug and a shaped engagement tool extension for applying rotational leverage to rotate said pole locking bar during installation and removal.

7. The safety parking bollard of claim 1, said pole collar insert plug further lateral retractable locking pins extending outward from said lower end which can be locked into place within upper radial pin holes within said hollow pole as said upper end of said hollow pole once inserted within said inner linear channel and said pole collar insert plug is secured within said upper opening.

8. A safety parking bollard for blocking movement of a vehicle for anti-theft purposes comprising:
a ground base member defining a flat lower surface secured to a ground surface by a plurality of ground anchor bolts, the ground base member further defining a tapered upper surface having a recessed cavity with a fin extension slot and extending a central locking pedestal with a lateral locking slot;
a base ring cover fitted within an inner margin of said recessed cavity defining a central bore and a fin extension slot, aligning said fin extension slot of said base ring cover and said fin extension slot of said ground base member;
a pole base defining a lower end with a lower pole slot, an outer surface defining a plurality of radial fins, an upper end defining an upper pole slot, with the lower pole slot and the upper pole slot connecting a hollow pole base tube;
a hollow pole defining a lower end forming a lower opening, an upper end defining an upper opening forming an inner linear channel from said upper end to said lower end, and defining upper radial pin holes, medial radial pin holes and lower radial pin hole;
an anti-theft pillar inserted within said inner linear channel and secured within said inner linear channel, said anti-theft pillar defining a lower rod support receiver forming a central locking slot and three or more lower rod support bores, an upper rod support receiver forming a central locking slot and three or more vertical rod channels, and at least three steel rods, respectively defining lower ends and terminal upper ends which are rotatably engaged within said rod support bores and said vertical rod channels;
a pole locking bar defining a lower end extending a pair of vertically oriented fixed lower locking extension pins and an upper end defining a shaped engagement tool extension; and
a pole collar insert plug defining a lower surface forming at least three rod receiver bores receiving said terminal upper ends of said respective steel rods in a rotatable engagement, further defining a lower end, and upper end defining an expanded collar and a lock receiver within which is secured a metal lock engaging a proprietary key, wherein said pole locking bar is inserted through said central locking slots of said upper and lower rod support receivers of said anti-theft pillar with said lower end of said pole locking bar inserted into said lateral locking slot of said central locking pedestal of said ground base member and said central bore of said base ring cover, rotating said pole locking bar to capture said fixed lower locking extension pins above said lateral locking slot and below said lower rod support receiver, after which said pole collar insert plug is installed within said upper opening of said hollow pole and engaging the lock to prevent disengagement of said pole collar insert plug and preventing access to said hollow pole and all its contents, said pole locking bar retaining all components of said safety parking bollard from removal from said secured ground base member until such time as the key unlocks said metal lock and the pole locking bar is rotated and removed from said hollow pole allowing disassembly of the safety parking bollard above said ground base member.

9. The safety parking bollard of claim 8, said ground base member further comprising a tapered upper surface, said plurality of ground anchor bolts inserting within respective bolt anchor channels defined within said recessed cavity within said ground base member, said ground recessed cavity further defining an inner margin with an upper expanded rim, and a central locking pedestal defining said lateral locking slot.

10. The safety parking bollard of claim 8, further comprising said base ring cover seated within an inner margin of a recessed cavity within said ground base member, said fine extension slots of said cover base ring aligned with said fin extension slots of said ground base member.

11. The safety parking bollard of claim 8, said pole base further defining said radial fins installed within said fin extension slots of said ground base member and said pole base fin extension slots preventing rotation of said hollow pole once installed within said ground base member.

12. The safety parking bollard of claim 8, said anti-theft pillar further comprising:
said lower rod support receiver defining said central locking slot, lower retractable locking pins and three or more lower rod support bores;
said upper rod support receiver defining said central locking slot, medial retractable locking pins and three or more vertical rod channels; and
said three or more steel rods defining said lower ends rotatably set within said lower rod support bores and passing through said vertical rod channels of said upper rod support receiver, each steel rod extending said terminal upper end above said upper rod support receiver into rod receiver bores located within said lower surface of said pole collar insert plug.

13. The safety parking bollard of Claim, the pole locking bar further comprising an upper end further comprising a vertical channel slot adapted to receive depending lock tang from said metal lock to prevent rotation of said lock within said pole collar insert plug and a shaped engagement tool extension for applying rotational leverage to rotate said pole locking bar during installation and removal.

14. The safety parking bollard of claim 8, said pole collar insert plug further lateral retractable locking pins extending outward from said lower end which can be locked into place within said upper radial pin holes of said hollow pole at said upper end of said hollow pole once inserted within said inner linear channel and said pole collar insert plug is secured within said upper opening, said metal lock prohibiting depression and thus removal of said lateral locking pins within said upper radial pin holes once said metal lock is locked within said lock receiver.

15. The safety parking bollard of claim 8, further comprising any other components, features or elements as disclosed in the specification and drawing.
